(19) United States
(12) Patent Application Publication
(10) Pub. No.: US 2023/0358262 A1
(43) Pub. Date: Nov. 9, 2023

(54) SECTIONAL ARCHED TUNNEL CONNECTED BY TENSION

(71) Applicant: Lifen YE, Zhejiang (CN)

(72) Inventor: Lifen YE, Zhejiang (CN)

(21) Appl. No.: 17/857,160

(22) Filed: Jul. 4, 2022

(30) Foreign Application Priority Data
May 7, 2022 (CN) 202221082477.5

(51) Int. Cl. F16B 7/04; E04B 1/32; A01G 13/02

(52) U.S. Cl. CPC F16B 7/0426; E04B 1/3205; A01G 13/0231

(57) ABSTRACT

The present utility model relates to the technical field of agricultural planting equipment, in particular to a sectional arched tunnel connected by tension, which comprises a first connecting rod and a second connecting rod between which a metal connector is connected. Both sides of a surface of the metal connector are provided with threaded connection holes, and both ends of the metal connector are provided with connecting holes. The present utility model can adapt to different ridge widths by changing number and bending amplitude of the connecting rods and it is convenient to connect without pressing, so as to meet requirements for different ridge widths.

### BACKGROUND OF THE INVENTION

The present utility model relates to the technical field of agricultural planting equipment, in particular to a sectional arched tunnel connected by tension.

Arched tunnels are generally made of bamboo poles and cement columns, and have a service life of 3 to 10 years. The arched tunnels have arc roofs which are covered with plastic films. The arched tunnels are also called double-arched tunnels, bread-shaped tunnels or freeze-proof tunnels, suitable for planting and farming in Southern China as well as Northern China in spring, summer and autumn. The arched tunnels have lower thermal insulation performance than plastic houses. Two or three layers of films can be provided in the arched tunnels to increase night temperature.

However, existing arched tunnels have low strength in actual use, and weak adaptability to different ridge widths and weak resistance to bending stress, and cannot flexibly meet the requirements of arch tunnels for different ridge widths.

### BRIEF SUMMARY OF THE INVENTION

In order to solve the above technical problems, the present utility model provides the following technical solution:

A sectional arched tunnel connected by tension is provided, comprising a first connecting rod and a second connecting rod. A metal connector is connected between the first connecting rod and the second connecting rod, both sides of a surface of the metal connector are provided with threaded connection holes, and both ends of the metal connector are provided with connecting holes. The threaded connection holes are communicated with the connecting holes.

Preferably, a stop block is provided inside the metal connector, and the surface of the metal connector is concave at the stop block.

Preferably, both the first connecting rod and the second connecting rod are in snap connection with the metal connector through the connecting holes, and the stop block is located at an inner middle position of the metal connector.

Preferably, both sides of the surface of the metal connector are connected with bolts through the threaded connection holes, and height of the bolts is greater than depth of the threaded connection holes.

Preferably, the bolts are in threaded connection with the threaded connection holes, and bottom ends of the bolts are in contact with the first connecting rod and the second connecting rod.

Preferably, both the first connecting rod and the second connecting rod are made of a high-strength elastic material, and the metal connector is made of a bending resistant metal material.

The embodiment of the present utility model provides a sectional arched tunnel connected by tension and has the following beneficial effects: the first connecting rod and the second connecting rod are connected with the metal connector and bent. Tension generated by the bending of the connecting rods increases a static friction force between the connecting rods and an inner wall of the metal connector, thus connecting the connecting rods tightly together. A long rod formed by connecting a plurality of connecting rods keeps good integrity and high strength in a bending state. The present utility model can adapt to different ridge widths by changing number and bending amplitude of the connecting rods; at the same time, the bolts are inserted into the threaded connection holes at both sides of the metal connector to limit the connecting rods and the metal connector, thus avoiding loosening and falling off of the first connecting rod and the second connecting rod from the metal connector, and improving the stability of the arched tunnel.

1. By providing the first connecting rod, the second connecting rod and the metal connector, the first connecting rod and the second connecting rod are connected with the metal connector and bent. The tension generated by the bending of the connecting rods increases a static friction force between the connecting rods and an inner wall of the metal connector, thus connecting the connecting rods tightly together. A long rod formed by connecting a plurality of connecting rods keeps good integrity and high strength in a bending state. The present utility model can adapt to different ridge widths by changing number and bending amplitude of the connecting rods and it is convenient to connect without pressing, so as to meet requirements for different ridge widths.

2. By providing the threaded connection hole and the bolts, after the connecting rods are connected, the bolts are in threaded connection with the threaded connection holes in the surface of the metal connector, and the bolts can be connected with the metal connector and the connecting rods, so that the bolts are rotationally inserted into the threaded connection holes to limit the connecting rods and the metal connector. In this way, the bolt presses against the connecting rods, avoiding loosening and falling off of the first connecting rod and the second connecting rod from the metal connector, thus improving the stability of the arched tunnel.

### BRIEF DESCRIPTION OF THE DRAWINGS

The drawings are intended to provide a further understanding of the present utility model, constitute a part of the Description, serve to explain the present utility model together with embodiments of the utility model, and do not constitute a limitation to the present utility model. In the drawings:

FIG. 1 is an overall structural diagram of the present utility model;

FIG. 2 is a structural diagram of the metal connector of the present utility model.

In the drawings: 1. first connecting rod; 2. metal connector; 3. bolt; 4. second connecting rod; 5. connecting hole; 6. threaded connection hole; 7. stop block.

### DETAILED DESCRIPTION OF THE INVENTION

Preferred embodiments of the present utility model are described below in conjunction with the attached drawings. It should be understood that the preferred embodiments described herein are only used to illustrate and explain the present utility model rather than defining the present utility model.

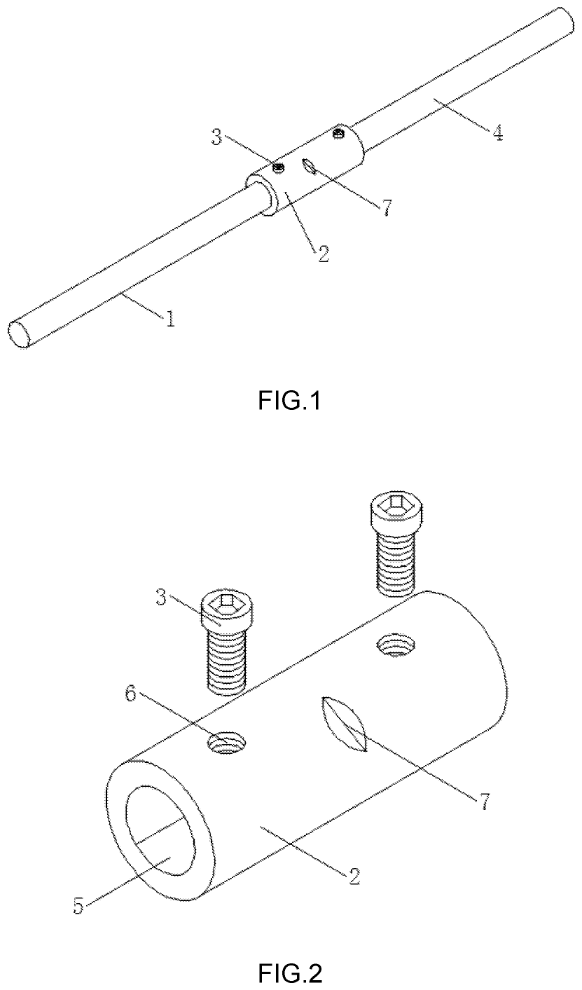

Embodiment: As shown in FIGS. 1-2, a sectional arched tunnel connected by tension, comprises a first connecting rod 1 and a second connecting rod 4. A metal connector 2 is connected between the first connecting rod 1 and the second connecting rod 4, both sides of a surface of the metal connector 2 are provided with threaded connection holes 6, and both ends of the metal connector 2 are provided with connecting holes 5; the threaded connection holes 6 are communicated with the connecting holes 5, so that the first connecting rod 1 is connected with the second connecting rod 4 through the metal connector 2, and tension generated by bending of the connecting rods increases a static friction force between the connecting rods and an inner wall of the metal connector 2, thus connecting the connecting rods tightly together.

Specifically, referring to FIG. 2, a stop block 7 is provided inside the metal connector 2, and the surface of the metal connector 2 is concave at the stop block 7, so that connection of the connecting rods can be limited by the stop block 7, thus preventing the connecting rods from passing directly through the metal connector 2.

Specifically, referring to FIGS. 1-2, both the first connecting rod 1 and the second connecting rod 4 are in snap connection with the metal connector 2 through the connecting holes 5, and the stop block 7 is located at an inner middle position of the metal connector 2, so that the first connecting rod 1 is connected with the second connecting rod 4 through the metal connector 2 and bent, and the tension generated by bending of the connecting rods increases the static friction force between the connecting rods and the inner wall of the metal connector 2.

Specifically, referring to FIGS. 1-2, both sides of the surface of the metal connector 2 are connected with bolts 3 through the threaded connection holes 6, so that connection stability of the metal connector 2 can be improved by the bolts 3, and height of the bolts 3 is greater than depth of the threaded connection holes 6, facilitating the connection between the bolts 3 and the metal connector 2.

Specifically, referring to FIGS. 1-2, the bolts 3 are in threaded connection with the threaded connection holes 6, and bottom ends of the bolts 3 are in contact with the first connecting rod 1 and the second connecting rod 4, so that the bolts 3 are connected between the connecting rods and the metal connector 2 through the threaded connection holes 6, thus improving stability of the arched tunnel and avoiding loosening and falling off.

Specifically, referring to FIG. 1, both the first connecting rod 1 and the second connecting rod 4 are made of a high-strength elastic material, so that the first connecting rod 1 and the second connecting rod 4 can be bent; and the metal connector 2 is made of a bending resistant metal material in order to increase a static friction force between the connecting rods and an inner wall of the metal connector 2. The present utility model can adapt to different ridge widths by changing number and bending amplitude of the connecting rods.

The operating principle is as follows: The first connecting rod 1 and the second connecting rod 4 are connected with the metal connector 2 and bent. The tension generated by the bending of the connecting rods increases the static friction force between the connecting rods and the inner wall of the metal connector 2, thus connecting the connecting rods tightly together. A long rod formed by connecting a plurality of connecting rods keeps good integrity in a bending state. The present utility model can adapt to different ridge widths by changing number and bending amplitude of the connecting rods, and it is convenient to connect without pressing. Meanwhile, after the connecting rods are connected, the bolts 3 are in threaded connection with the threaded connection holes 6 in the surface of the metal connector 2, and the bolts 3 can be connected with the metal connector 2 and the connecting rods, so that the bolts 3 are rotationally inserted into the threaded connection holes 6 to limit the connecting rods and the metal connector 2. In this way, the bolts 3 presses against the connecting rods, avoiding loosening and falling off of the first connecting rod 1 and the second connecting rod 4 from the metal connector 2, thus improving the stability of the arched tunnel.

What is claimed is:

1. A sectional arched tunnel connected by tension, comprising a first connecting rod (1) and a second connecting rod (4), wherein a metal connector (2) is connected between the first connecting rod (1) and the second connecting rod (4), both sides of a surface of the metal connector (2) are provided with threaded connection holes (6), and both ends of the metal connector (2) are provided with connecting holes (5); and the threaded connection holes (6) are communicated with the connecting holes (5).

2. The sectional arched tunnel connected by tension according to claim 1, wherein a stop block (7) is provided inside the metal connector (2), and the surface of the metal connector (2) is concave at the stop block (7).

3. The sectional arched tunnel connected by tension according to claim 2, wherein both the first connecting rod (1) and the second connecting rod (4) are in snap connection with the metal connector (2) through the connecting holes (5), and the stop block (7) is located at an inner middle position of the metal connector (2).

4. The sectional arched tunnel connected by tension according to claim 1, wherein both sides of the surface of the metal connector (2) are connected with bolts (3) through the threaded connection holes (6), and height of the bolts (3) is greater than depth of the threaded connection holes (6).

5. The sectional arched tunnel connected by tension according to claim 4, wherein the bolts (3) are in threaded connection with the threaded connection holes (6), and bottom ends of the bolts (3) are in contact with the first connecting rod (1) and the second connecting rod (4).

6. The sectional arched tunnel connected by tension according to claim 1, wherein both the first connecting rod (1) and the second connecting rod (4) are made of a high-strength elastic material, and the metal connector (2) is made of a bending resistant metal material.
